(19) United States
(12) Patent Application Publication
(10) Pub. No.: US 2009/0278697 A1
(43) Pub. Date: Nov. 12, 2009

(54) GPS unit that points home only for alzheimer victims

(75) Inventor: Robert Alvin Meilleur, North Bay (CA)

Correspondence Address: ROBERT A MEILLEUR, 208 KING ST W, NORTH BAY, ON, PIB528, CA

(73) Assignee: Greer Meilleur, Toronto (CA)

(21) Appl. No.: 12/151,989

(22) Filed: May 12, 2008

(51) Int. Cl. G08B 21/02

(52) U.S. Cl. 340/573.4; 342/357.06

(57) ABSTRACT

Alzheimer victims often get lost when they're out and about. They usually end up being brought back home by the police; I propose a GPS ((global positioning system) unit with only one function: POINTING HOME.

A GPS (global positioning system) can be programmed to do many things. One is “GO TO” and when location is chosen, an arrow points in that direction no mater what direction a person turns. I propose a GPS with one function only: POINTING HOME.

A caregiver or guardian can set it and lock it so it can't be changed until the Alzheimer victim has returned home.

1. I claim it will help Alzheimer victims find their way home

2. I claim it will give peace of mind to guardians or caregivers of Alzheimer victims

3. It will allow police services to concentrate on their own tasks
